(19) United States
(12) Patent Application Publication
(10) Pub. No.: US 2026/0017144 A1
(43) Pub. Date: Jan. 15, 2026

(54) DATA BACKUP METHOD, MEDIUM AND ELECTRONIC DEVICE

(71) Applicant: Beijing Volcano Engine Technology Co., Ltd., Beijing (CN)

(72) Inventors: Jiafu JIANG, Beijing (CN); Liqiang FAN, Beijing (CN); Yu XIE, Beijing (CN); Jun TANG, Beijing (CN)

(21) Appl. No.: 19/180,550

(22) Filed: Apr. 16, 2025

(30) Foreign Application Priority Data
Jul. 10, 2024 (CN) 202410925805.0

(51) Int. Cl. G06F 11/14

(52) U.S. Cl. CPC G06F 11/1451; G06F 11/1464; G06F 11/1469

(57) ABSTRACT

A data backup method, a medium and an electronic device are provided. The data backup method includes: generating a recovery point deletion task, where the recovery point deletion task is used to instruct to delete a target recovery point in a backup repository, and the backup repository is used to manage backup data and backup indexes corresponding to respective recovery points; and delivering the recovery point deletion task to a backup work service node, and instructing the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

### CROSS-REFERENCE TO RELATED APPLICATION

This application claims the priority to and benefits of the Chinese Patent Application No. 202410925805.0, filed on Jul. 10, 2024, the entire disclosure of which is incorporated herein by reference as portion of the present application.

### TECHNICAL FIELD

The present disclosure relates to the field of computer technologies and, in particular, to a data backup method and apparatus, a medium, an electronic device and a program product.

### BACKGROUND

Data backup is not only an effective means against hardware failures, natural disasters, or malicious attacks, but also can provide strong support for business continuity. As the cornerstone of data security, file system backup can ensure data integrity and availability, and provide users with a reliable way to deal with various potential threats.

However, when it is necessary to delete a certain recovery point in a file system backup, since the recovery points corresponding to the full backup and subsequent incremental backups form a recovery chain, once a certain recovery point in the recovery chain is deleted, subsequent recovery points of the backup data cannot be used.

In the related art, in order to enable subsequent recovery points to continue to be used when deleting a recovery point, data merging and relocation are performed when deleting the recovery point, more metadata is maintained, or soft deletion and periodic garbage collection (GC) are performed. However, these methods are not only inefficient, but also occupy more computer resources.

### SUMMARY

This Summary is provided to introduce concepts in a simplified form that are described in detail below in the Detailed Description section. This Summary is not intended to identify key features or essential features of the claimed technical solutions, nor is it intended to be used to limit the scope of the claimed technical solutions.

In a first aspect, the present disclosure provides a data backup method, including:
generating a recovery point deletion task, where the recovery point deletion task is used to instruct to delete a target recovery point in a backup repository, and the backup repository is used to manage backup data and backup indexes corresponding to respective recovery points; and
delivering the recovery point deletion task to a backup work service node, and instructing the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

In a second aspect, the present disclosure provides a data backup apparatus, including:
a task generation module configured to generate a recovery point deletion task, where the recovery point deletion task is used to instruct to delete a target recovery point in a backup repository, and the backup repository is used to manage backup data and backup indexes corresponding to respective recovery points; and
a sending module configured to deliver the recovery point deletion task to a backup work service node, and instruct the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

In a third aspect, the present disclosure provides a computer-readable medium having a computer program stored thereon, where when the computer program is executed by a processing apparatus, the steps of the method according to the first aspect are implemented.

In a fourth aspect, the present disclosure provides an electronic device, including:
a storage apparatus having a computer program stored thereon; and
a processing apparatus configured to execute the computer program in the storage apparatus to implement the steps of the method according to the first aspect.

In a fifth aspect, the present disclosure provides a computer program product, including a computer program which, when executed by a processor, implements the steps of the method according to the first aspect.

### BRIEF DESCRIPTION OF DRAWINGS

The above and other features, advantages and aspects of embodiments of the present disclosure become more apparent with reference to the following Detailed Description in conjunction with the drawings. Throughout the drawings, the same or similar reference numerals refer to the same or similar elements. It should be understood that the drawings are schematic and that parts and elements are not necessarily drawn to scale. In the drawings:

FIG. 1 is a schematic diagram of a structure of a data backup system according to some embodiments;

FIG. 2 is a flowchart of a data backup method according to some embodiments;

FIG. 3 is a schematic diagram of backup data according to some embodiments;

FIG. 4 is a schematic diagram of a cloud server according to some embodiments;

FIG. 5 is a schematic diagram of a data organization form according to some embodiments;

FIG. 6 is a flowchart of a data backup method according to other embodiments;

FIG. 7 is a schematic diagram of a structure of a data backup apparatus according to some embodiments; and

FIG. 8 is a schematic diagram of a structure of an electronic device according to some embodiments.

### DETAILED DESCRIPTION

The embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein, but rather these embodiments are provided for a more thorough and complete understanding of the present disclosure. It should be understood that the drawings and embodiments of the present disclosure are only for illustrative purposes and are not intended to limit the scope of protection of the present disclosure.

It should be understood that the various steps recited in the method implementations of the present disclosure may be performed in different orders and/or in parallel. Furthermore, method implementations may include additional steps and/or omit performing illustrated steps. The scope of the present disclosure is not limited in this respect.

As used herein, the term “include/comprise” and variations thereof are open-ended inclusions, that is, “include/comprise but not limited to”. The term “based on” is “based, at least in part, on”. The term “one embodiment” means “at least one embodiment”; the term “another embodiment” means “at least one additional embodiment”; and the term “some embodiments” means “at least some embodiments”. Related definitions of other terms will be given in the following description.

It should be noted that concepts such as “first” and “second” mentioned in the present disclosure are only used to distinguish between different apparatuses, modules or units, and are not used to limit the order or interdependence of the functions performed by these apparatuses, modules or units.

It should be noted that the modifications of “one” and “multiple” mentioned in the present disclosure are illustrative and not restrictive, and those skilled in the art should understand that the modifications should be understood as “one or more” unless the context clearly indicates otherwise.

The names of messages or information exchanged between multiple apparatuses in the implementations of the present disclosure are only used for illustrative purposes, and are not intended to limit the scope of these messages or information.

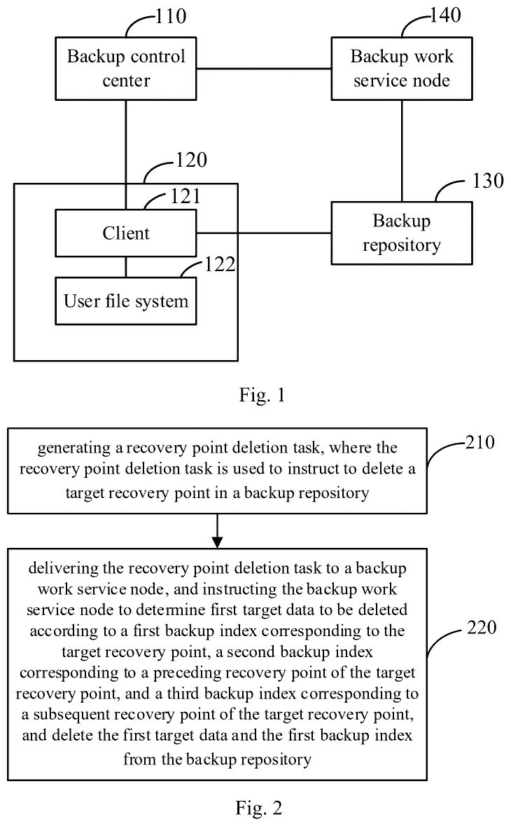

FIG. 1 is a schematic diagram of a structure of a data backup system according to some embodiments. As shown in FIG. 1, an embodiment of the present disclosure provides a data backup system, and the data backup system includes a backup control center 110, a cloud server 120, and a database server.

The backup control center 110 is configured to manage a backup plan, and periodically send a data backup task to a client 121 (a client) deployed in the cloud server 120 according to backup time indicated by the backup plan, so that the client 121 executes the data backup task to complete one data backup, and backs up data in a user file system 122 (which may also be referred to as a backup source) in the cloud server 120 to a backup repository 130 in the database server.

Furthermore, the backup control center 110 is further configured to manage the backup source, the backup repository 130, the recovery point, the data backup task, and the lifecycle of the data recovery task in the cloud server 120, where the lifecycle includes creation, deletion, update, and so on.

The cloud server 120 is configured to access the user file system 122 in the cloud server 120 through the client 121 deployed in the cloud server 120, execute the data backup task, and upload the backup index and the backup data to the backup repository 130, or execute the data recovery task to recover the backup data in the backup repository 130 to the designated user file system 122.

The database server is configured to store the backup data and the corresponding backup index through the deployed backup repository 130.

In addition, the backup control center 110 may further execute a recovery point deletion task through a backup work service node (Backup Worker) 140 to delete a recovery point in the backup repository 130.

FIG. 2 is a flowchart of a data backup method according to some embodiments. As shown in FIG. 2, an embodiment of the present disclosure provides a data backup method, and the method may be applied to the backup control center 110 shown in FIG. 1. It should be noted that the backup control center may be a backup management server. As shown in FIG. 2, the method may include the following steps.

Step 210: generating a recovery point deletion task, where the recovery point deletion task is used to instruct to delete a target recovery point in a backup repository.

Here, the recovery point deletion task may be configured by the user through the backup control center. That is, the recovery point deletion task may be configured through the backup control center to instruct the backup control center to delete the target recovery point from the backup repository in the database server. It should be understood that the recovery point deletion task may actually be understood as deleting the backup data and the backup index corresponding to the target recovery point.

The backup repository in the database server is used to store backup data of respective recovery points and backup indexes corresponding to the backup data, and to manage the backup data and the backup indexes corresponding to the respective recovery points.

Exemplarily, the backup repository may adopt an object storage data storage architecture, or the backup repository may adopt a NAS (Network Attached Storage) data storage architecture. The object storage is a system that stores data as objects, and each object usually includes data and related metadata. The network attached storage is a file-level storage device that allows access and sharing of data through standard network protocols (such as NFS, SMB/CIFS).

It should be noted that the backup control center may record a recovery point corresponding to each data backup, and the user may indicate the recovery point that needs to be deleted as the target recovery point in the recovery point deletion task.

The recovery point refers to the state where data is successfully backed up and can be used to restore to a specific point in time. When one data backup is performed, the recovery point corresponding to the current data backup may be generated, and the recovery point is associated with the backup data and the backup index corresponding to the current data backup.

Step 220: delivering the recovery point deletion task to a backup work service node, and instructing the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

Here, the backup control center may send the recovery point deletion task to the backup work service node (Backup Worker) to enable the backup work service node to execute the recovery point deletion task.

The backup work service node may be a work process, which is invisible to users and is responsible for executing the recovery point deletion task. It should be noted that the backup work service node may be deployed inside the backup control center as a part of the backup control center. Certainly, the backup work service node may also be deployed on one or more nodes of the data backup system as an independent service or process. For example, the backup work service node may be deployed on the cloud server, the database server, or other computing resources of the data backup system.

The backup work service node may acquire the first backup index corresponding to the target recovery point from the backup repository, acquire the second backup index corresponding to the preceding recovery point of the target recovery point from the backup repository, and acquire the third backup index corresponding to the subsequent recovery point of the target recovery point from the backup repository in response to the recovery point deletion task.

The recovery chain is a chain formed by recovery points generated by multiple data backups for the same backup source, and a first recovery point in the recovery chain may usually be a full backup of the backup source. On the recovery chain, a former recovery point of a recovery point is referred to as a preceding recovery point. On the recovery chain, a latter recovery point of a recovery point is referred to as a subsequent recovery point. The preceding recovery point corresponding to the target recovery point is a former recovery point of the target recovery point on the recovery chain, and the subsequent recovery point corresponding to the target recovery point is a latter recovery point of the target recovery point on the recovery chain.

The backup index includes metadata of all backup data of a certain recovery point, including information such as a path of the backup data and a modification time stamp of the backup data.

Then, the backup work service node determines, in the backup repository, the first target data to be deleted according to the first backup index, the second backup index, and the third backup index. It should be noted that the first target data to be deleted may be backup data other than the backup data inherited from the second backup index and the backup data referenced by the third backup index in all backup data included in the first backup index.

It should be noted that the recovery point deletion task may include a recovery point identification corresponding to the target recovery point. Certainly, if the target recovery point has a preceding recovery point and/or a subsequent recovery point, the recovery point deletion task may also include a preceding recovery point identification corresponding to the preceding recovery point and/or a subsequent recovery point identification corresponding to the subsequent recovery point. The backup work service node acquires the first backup index from the backup repository through the recovery point identification corresponding to the target recovery point, acquires the second backup index from the backup repository through the preceding recovery point identification, and acquires the third backup index from the backup repository through the subsequent recovery point identification in response to the recovery point deletion task.

It should be understood that if the target recovery point does not have the preceding recovery point and/or the subsequent recovery point, the second backup index and/or the third backup index may not be acquired. For example, if the target recovery point does not have the preceding recovery point, the first target data to be deleted is determined according to the first backup index and the third backup index.

After determining the first target data to be deleted, the backup work service node deletes the first target data and the first backup index from the backup repository of the database server to complete deleting the target recovery point.

It should be noted that after deleting the first target data and the first backup index from the backup repository, the backup control center may delete the recovery point identification corresponding to the target recovery point recorded by the backup control center. If the target recovery point has a backup checkpoint, the backup checkpoint corresponding to the target recovery point is deleted from the backup repository.

It should be noted that in the embodiment of the present disclosure, the recovery point is deleted by directly deleting the first target data and the first backup index in the backup repository from the backup repository without data relocation of the first target data or backup index merging, not to mention recovering useless backup data through periodic GC, and extra maintenance of metadata of data reference.

Therefore, by generating a recovery point deletion task, delivering the recovery point deletion task to a backup work service node, and instructing the backup work service node to determine first target data to be deleted according to a first backup index corresponding to a target recovery point, a second backup index corresponding to a preceding recovery point of the target recovery point, and a third backup index corresponding to a subsequent recovery point of the target recovery point, and delete the first target data and the first backup index from a backup repository, the first target data and the first backup index of the target recovery point in the backup repository can be directly deleted without data relocation or backup index merging, not to mention recovering useless backup data through periodic GC, and extra maintenance of metadata of data reference, thereby not only greatly saving computing resources and storage space, but also improving the efficiency of recovery point deletion.

In some implementations that may be implemented, in step 220, first backup data that is not inherited from the second backup index may be determined from backup data included in the first backup index according to the first backup index and the second backup index, second backup data that is not referenced by the third backup index is determined from the first backup data according to the first backup index and the third backup index, and the second backup data is determined as the first target data.

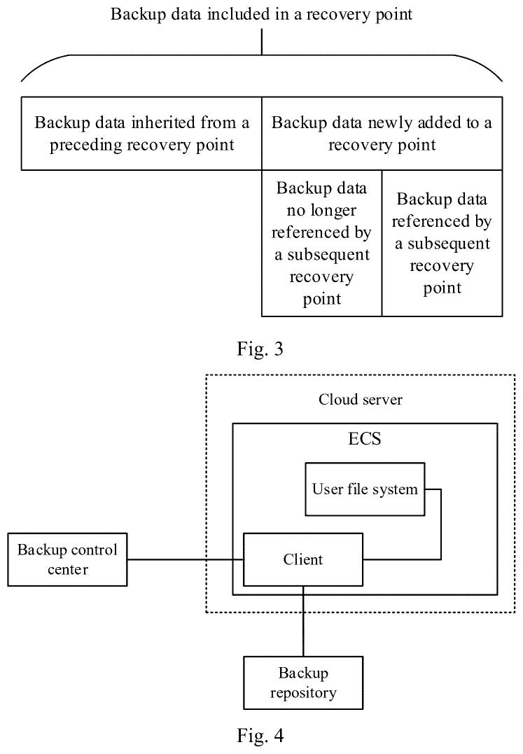

Here, FIG. 3 is a schematic diagram of backup data according to some embodiments. As shown in FIG. 3, the backup data included in one recovery point may include backup data inherited from a preceding recovery point and backup data newly added to the recovery point. The backup data newly added to the recovery point may further include two parts, namely the backup data that is no longer referenced by a subsequent recovery point and the backup data that is referenced by the subsequent recovery point.

The backup data inherited from the preceding recovery point should not be deleted because the preceding recovery point is still referencing the backup data. Similarly, the backup data referenced by the subsequent recovery point is still referenced by the subsequent recovery point, and thus the backup data referenced by the subsequent recovery point should not be deleted.

In the embodiment of the present disclosure, the backup work service node may determine, from all backup data included in the first backup index, the first backup data that is not inherited from the second backup index by comparing the first backup index with the second backup index. The first backup data may be understood as backup data newly added to the target recovery point relative to the preceding recovery point. Then, the second backup data that is not referenced by the third backup index is determined from the first backup data by comparing the first backup index with the second backup index. The second backup data may be understood as backup data newly added to the target recovery point relative to the preceding recovery point and not referenced by the subsequent recovery point. Therefore, the second backup data is backup data that can be safely deleted, and the second backup data is determined as the first target data to be deleted.

In some embodiments, when deleting the target recovery point, the backup control center may generate the recovery point deletion task. The recovery point deletion task includes the recovery point identification corresponding to the target recovery point, the preceding recovery point identification corresponding to the preceding recovery point, and the subsequent recovery point identification corresponding to the subsequent recovery point. Then, the backup control center delivers the recovery point deletion task to the backup work service node to instruct the backup work service node to receive the recovery point deletion task, acquire the first backup index from the backup repository according to the recovery point identification corresponding to the target recovery point, acquire the second backup index from the backup repository through the preceding recovery point identification, and acquire the third backup index from the backup repository through the subsequent recovery point identification. Next, the backup work service node constructs corresponding data sets according to the first backup index, the second backup index, and the third backup index, and each data set includes all backup data in the backup index of the corresponding recovery point. The first backup index corresponds to a first data set, the second backup index corresponds to a second data set, and the third backup index corresponds to a third data set. A set to be deleted is equal to the first data set minus the second data set minus the third data set, and all backup data included in the set to be deleted is the first target data.

Therefore, through the above implementations, when deleting the recovery point, the first target data that can be safely deleted can be directly deleted to realize direct deletion of the recovery point without data relocation or backup index merging, not to mention recovering useless backup data through periodic GC, and extra maintenance of metadata of data reference, thereby not only greatly saving computing resources and storage space, but also improving the efficiency of recovery point deletion.

In some implementations that may be implemented, as shown in FIG. 1, the data backup system may further include a cloud server. The cloud server may be deployed with Elastic Compute Service (ECS), and a user file system may be mounted on the ECS.

FIG. 4 is a schematic diagram of a cloud server according to some embodiments. As shown in FIG. 4, the ECS may be deployed in the cloud server, and the user file system and the client are deployed in the ECS, and the client communicates with the backup control center, the backup repository, and the user file system, respectively.

It should be noted that the schematic diagram of the architecture of the cloud server shown in FIG. 4 is only for explanatory purposes, and does not limit the specific architecture of the cloud server. For example, one or more ECSs may be deployed on the cloud server, and the client may be deployed inside the cloud server instead of being directly deployed inside the ECS.

Accordingly, the backup control center may determine a data backup task and deliver the data backup task to the cloud server. The data backup task is used to enable the cloud server to access a first backup source through a client based on an access protocol adapted to a type of the first backup source in a preconfigured access protocol, and execute the data backup task to generate a target backup index corresponding to second target data, and upload the target backup index and the second target data to the backup repository.

Here, the data backup task is used to instruct to back up the second target data of the first backup source in the cloud server. The first backup source may be a user file system mounted on the ECS. The second target data may be designated data in the first backup source that needs to be backed up.

It should be understood that the data backup task may be periodically generated by the backup control center according to the time specified in the backup plan and delivered to the client. The backup plan may be a periodic backup plan created for a certain backup source and executed regularly at a fixed time. In the backup plan, parameters such as a corresponding backup source, a backup path, a backup start time, a backup execution interval, and a backup data retention time may be set so that data of the backup source is periodically and continuously backed up. Certainly, the data backup task may also be a backup task set by the user.

The backup control center generates the data backup task and delivers the data backup task to the client deployed in the cloud server.

It should be noted that corresponding clients may be installed on different backup source systems and platforms, and the clients are used to execute the data backup task and the data recovery task delivered by the backup control center.

The client may access the first backup source based on the access protocol adapted to the type of the first backup source in the preconfigured access protocol. That is, the client supports communication with the backup source through a communication protocol adapted to the backup source, and the client supports communication with different types of backup repositories.

Exemplarily, in the embodiment of the present disclosure, the backup source may be a user file system using protocols such as POSIX, NFS, and SMB. According to different types of user file systems that need to be backed up, the client communicates with the user file system through the communication protocol adapted to the backup source, so that the client can adapt to not only the user file system of the POSIX protocol, but also user file systems of protocols such as NFS and SMB. In addition, the client also supports communication with different types of backup repositories, such as backup repositories using object storage, backup repositories using network attached storage, and the like.

The client deployed in the cloud server receives the data backup task delivered by the backup control center, accesses the first backup source through the access protocol adapted to the type of the first backup source in response to the data backup task, and executes the data backup task. When executing the data backup task, the client scans the first backup source to obtain the second target data that needs to be backed up as instructed by the data backup task, and generates the target backup index corresponding to the second target data based on the scanned second target data. Then the target backup index and the second target data are uploaded to the backup repository to complete execution of the data backup task.

It should be noted that in the data backup process, the client needs to perform operations such as traversing designated directories and files in the user file system, acquiring metadata (such as modification time) of the files, and reading file contents. Through the client, the above operations on the user file system can be supported regardless of the user file system of the POSIX protocol or the NAS protocol. Therefore, the data backup method provided by the embodiment of the present disclosure has strong universality.

Therefore, through the client, the data backup method can be applied to different types of user file systems and support different types of backup repositories, and is highly versatile.

It should be noted that when the amount of data corresponding to the data that needs to be backed up is large, multiple clients may be provided, and each client is responsible for backing up part of the data.

In some implementations that may be implemented, the backup repository may include user storage space, and the user storage space supports a tenant of the cloud server to access the backup indexes and the backup data.

The user storage space may be storage space on the cloud belonging to the user who uses the cloud services provided by the cloud server. The user storage space supports access by the user, so that the user can access the backup indexes and the backup data stored in the user storage space.

It should be noted that the backup repository may adopt an object storage data storage architecture, or may be another type of file system that can support storage for key-value pairs.

Exemplarily, the backup repository adopts an object storage data storage architecture or a network attached storage data storage architecture, and the user storage space includes a bucket in the object storage or a designated directory in the network attached storage.

When the backup repository is the object storage, the user storage space is the bucket in the object storage, and the bucket may store multiple backup data of one or more backup sources. When the backup repository is the network attached storage, the user storage space corresponds to one or more designated directories in the network attached storage, and the designated directories are used to store multiple backup data of one or more backup sources.

Accordingly, the cloud server may upload the target backup index and the second target data to the user storage space of the backup repository through the client.

Here, the user storage space supports access, so that the user can access the backup indexes and the backup data stored in the user storage space. That is, the backup indexes and the backup data are stored in the user storage space of the backup repository, and when the user needs to read certain backup data, the user may acquire the corresponding backup data by accessing the corresponding user storage space.

In the embodiment of the present disclosure, by using the user storage space supporting access to store the backup data and the backup indexes, the stored backup data can be accessed by the user. When the user needs to perform data analysis on the backup data, the user may read the corresponding backup data by accessing the user storage space, and perform data analysis on the backup data.

It should be understood that in the related art, backup data is all stored inside the database and is invisible to users. Only when the user needs to perform data recovery, the backup data stored in the database is recovered to a specific location. Through the data backup method provided by the embodiment of the present disclosure, the backup data and the backup indexes are stored in the user storage space of the backup repository, which can make the backup indexes and the backup data visible to the user, and the user can directly read the required backup data and backup indexes by accessing the corresponding user storage space.

Therefore, by storing the backup data and the backup indexes in the user storage space, the user can directly access the backup data and the backup indexes stored in the user storage space, thereby achieving secondary use of the backup data and the backup indexes.

In some implementations that may be implemented, the backup indexes are stored in the backup repository through a data organization form that is preset, and the data organization form includes at least one of the following parameters:

an environment identification used to characterize a business environment where the target backup sources corresponding to the backup indexes are located, a backup source type used to characterize the types of the target backup sources, backup source identifications corresponding to the target backup sources, recovery point identifications corresponding to the backup indexes, a backup directory used to store backup data corresponding to the backup indexes, and backup checkpoints corresponding to the backup indexes.

Here, the backup data and the corresponding backup index are stored in the backup repository. The backup data is the original data of the file. The backup data may be stored by using the backup source identification of the backup source and the file identification (such as path or inode) corresponding to the data as a key, and the data content as the value corresponding to the key. Subsequently, the corresponding backup data may be found directly through the key. The backup index includes metadata (such as data modification time, data path, and recovery point identification) of all backup data included in the recovery point.

In the embodiment of the present disclosure, the backup index is stored in the backup repository through the preset data organization form.

The environment identification (prefix) is used to represent the business environment where the target backup source is located, and the environment identification may vary according to different business environments. The backup source type (resource-type) is used to represent the type to which the target backup source belongs. The backup source identification (resource-id) is used to represent the corresponding backup source. For example, the backup source representation may be the unique identification corresponding to the target backup source. The recovery point identification is used to represent the recovery point corresponding to the backup index. The backup checkpoint is used to represent that the data backup corresponding to the backup index has been successfully completed. If a backup index has a corresponding backup checkpoint, it represents that the corresponding data backup task has been completed, and data up to a certain point in time has been successfully backed up. The backup directory (backup_index) is a directory used to save all metadata of the backup data.

FIG. 5 is a schematic diagram of a data organization form according to some embodiments. As shown in FIG. 5, when the backup repository is object storage, the backup index and the backup data are stored in the bucket of the object storage through the data organization form shown in FIG. 5.

Certainly, it should be understood that when the backup repository is network attached storage, the backup index and the backup data may also be stored in the designated directories of the network attached storage through the data organization form shown in FIG. 5.

The data is stored in the form of an object in the object storage, and each object has a unique key designation, and the key may be composed of multiple parts. For example, the key corresponding to the backup index generated by a certain backup may be: /cbr/filesystem_01/recovery_point_001/backup_index. The cbr represents the corresponding business environment, the filesystem_01 is the backup source identification corresponding to the user file system, the recovery_point_001 is the recovery point identification, and the backup_index is the corresponding backup directory. In the actual application scenario, the recovery point identification may further include other additional information. For example, after retrying, the recovery point identification may include the retried version.

It should be noted that backup_index is used to save metadata of all backup data of the current backup, and the metadata may be stored by line, and each line represents an actual piece of data. backup_index actually represents the file system of the backup data of a certain recovery point.

It should be noted that if the amount of backup data saved by backup_index is large, the backup data may be stored by splitting. For example, the path of the data may be calculated by hash and then divided into multiple objects for storage.

Therefore, by storing the backup index in the backup repository through the above preset data organization form, the backup index can be effectively organized and stored.

In some implementations that may be implemented, the backup index may also be displayed according to the data organization form in response to a viewing operation for the backup index.

Here, the backup control center may acquire the backup index read by the user from the backup repository, and display the backup index through the above data organization form.

Certainly, the backup index may also be viewed by the user terminal, and the user terminal may refer to a terminal device using cloud services. When the user needs to view a certain backup index in the backup repository, the backup index may be displayed on the user terminal through the above data organization information.

Exemplarily, when the user needs to view the backup index stored in the bucket of the object storage, the backup index may be displayed on the user terminal, corresponding to the bucket through the above data organization form in responding to a viewing operation for a certain bucket on the user terminal corresponding to the user, so that the backup index is visible to the user.

Therefore, through the above implementations, the backup index is visible to the user, so that the user can intuitively know the backup index read by the user and find the corresponding backup data according to the displayed backup index.

In some implementations that may be implemented, the data backup task may include an incremental backup task. Accordingly, the incremental backup task may include a target recovery point identification, a backup source identification corresponding to the first backup source, a preceding recovery point identification corresponding to the target recovery point identification, and a data backup parameter, and the data backup parameter is used to instruct to back up the second target data in the first backup source.

Here, the incremental backup refers to backing up a data space that has changed or been modified since the last backup. The last backup may be a full backup or an incremental backup, and before performing an incremental backup on a certain backup source, it is necessary to perform a full backup on the backup source once.

When initiating an incremental backup for the first backup source, the backup control center may generate the target recovery point identification, and the target recovery point identification is used to indicate the target backup index and the second target data corresponding to the current backup for the first backup source.

When the incremental backup needs to be performed on the first backup source, the backup control center may send the incremental backup task to the client of the cloud server. The incremental backup task includes the target recovery point identification, the backup source identification corresponding to the first backup source, the preceding recovery point identification corresponding to the target recovery point identification, and the data backup parameter. The data backup parameter may actually be understood as being used to describe that certain directories or data in the first backup source need to be backed up. The preceding recovery point identification corresponding to the target recovery point identification is the recovery point identification of the preceding recovery point of the recovery point corresponding to the current incremental backup.

Accordingly, the cloud server executes the incremental backup task through the client, determines a fourth backup index corresponding to the preceding recovery point identification according to the preceding recovery point identification, scans the first backup source indicated by the backup source identification through the client according to the data backup parameter, determines the second target data to be backed up in the first backup source, and generates the target backup index corresponding to the target recovery point identification according to the second target data. Then the cloud server determines incremental backup data in the second target data included in the target backup index through the client according to the target backup index and the fourth backup index, and uploads the target backup index and the incremental backup data to the backup repository through the client.

Here, the backup control center instructs the client of the cloud server to acquire the fourth backup index corresponding to the preceding recovery point identification through the preceding recovery point identification in response to the incremental backup task after receiving the incremental backup task. It should be noted that if a cache of the fourth backup index corresponding to the preceding recovery point identification is stored locally in the client, the fourth backup index may be acquired directly from the local. If the cache of the fourth backup index corresponding to the preceding recovery point identification is not stored locally in the client, the fourth backup index may be acquired from the backup repository through the preceding recovery point identification.

Then, the first backup source indicated by the backup source identification is scanned through the client according to the data backup parameter, the second target data to be backed up is determined in the first backup source, and the target backup index corresponding to the target recovery point identification is generated according to the second target data obtained through scanning.

Next, the incremental backup data is determined in the second target data included in the target backup index through the client according to the target backup index and the fourth backup index.

Exemplarily, each piece of the second target data in the target backup index may be traversed. If the traversed second target data does not exist in the fourth backup index, the second target data is the incremental backup data. If the traversed second target data exists in the fourth backup index and if the data modification time of the second target data is inconsistent with the data modification time of the corresponding data in the fourth backup index, it represents that the second target data has changed since the last backup, and the second target data is the incremental backup data. If the data modification time is consistent, it represents that the second target data has not changed since the last backup, and the second target data is not the incremental backup data.

After determining the incremental backup data, the target backup index and all the incremental backup data are written into the backup repository for storage. It should be noted that if the backup repository adopts an object storage data storage architecture, the client may upload the target backup index and the incremental backup data to the object storage through an interface (API) corresponding to the object storage. If the backup repository adopts a network attached storage data storage architecture, the client may upload the target backup index and the incremental backup data to the network attached storage through the NAS protocol.

It should be understood that both the object storage and the network attached storage may be supported by the client. The object storage supports storage according to a key. For the network attached storage, the client may convert the read and write operations of the key into the read and write operations of the data path, so that the client can easily support the object storage and the network attached storage.

It should be noted that in the process of uploading the target backup index and the incremental backup data, if certain data is deleted, the corresponding data in the target backup index also needs to be deleted.

After the uploading of the target backup index and the incremental backup data is completed, a checkpoint may be written into the target backup index to represent that the current incremental backup has been successfully completed. Certainly, the target backup index may also be saved locally in the client in the form of a file for the next backup.

It should be noted that in the incremental backup process, the client may perform the following operations on the backup source: traversing directories and data in the backup source, acquiring metadata (such as data modification time) of the data, and reading data content of the data.

Therefore, through the above implementations, the incremental backup can be quickly performed on the backup source, and the incremental backup task is executed by the client, so that backup sources of different protocols can be supported, which has strong universality.

It should be understood that the client deployed in the cloud server may be created in the cloud server by the backup control center. That is, the backup control center may create, in the cloud server, the client whose access protocol can adapt to the type of the backup source used by the cloud server according to the type of the backup source used by the cloud server. For different types of backup sources, clients with different access protocols may be created.

In some implementations that may be implemented, the data backup task may include a full backup task. Accordingly, the full backup task may include a recovery point identification, a backup source identification, and a data backup parameter.

Here, when initiating a full backup for the backup source, the backup control center may generate a corresponding recovery point identification, where the recovery point identification is used to indicate the backup index and the backup data corresponding to the current backup for the backup source.

When the full backup needs to be performed on a backup source, the backup control center may send the full backup task to the client of the cloud server, and the full backup task includes the recovery point identification, the backup source identification, and the data backup parameter.

Accordingly, the cloud server executes the full backup task through the client, scans the backup source indicated by the backup source identification according to the data backup parameter, determines the data to be backed up, and generates the backup index corresponding to the recovery point identification according to the data to be backed up, and uploads the backup index and the data to be backed up to the backup repository.

It should be noted that the difference between the full backup and the incremental backup is that the full backup does not need to use the preceding recovery point, nor does it need to compare with the backup index corresponding to the preceding recovery point. For the specific operations of the client in executing the full backup task, reference may be made to the above specific operations of the client in executing the incremental backup task.

In some implementations that may be implemented, the backup control center determines a data recovery task, executes the data recovery task through a client deployed in the cloud server, acquires a fifth backup index corresponding to third target data from the backup repository, and writes the third target data into a second backup source according to the fifth backup index through the client.

Here, the data recovery task is used to instruct to recover the third target data in the backup repository to the second backup source that is designated in the cloud server.

The data recovery task may include at least one of a recovery point identification, a backup source identification, a data recovery parameter, a destination backup source identification, and a target directory. The recovery point identification is used to instruct to recover the backup data corresponding to the recovery point identification to the second backup source corresponding to the destination backup source identification. The target directory refers to the data recovery path corresponding to the second backup source. The data recovery parameter is used to instruct the third target data that needs to be recovered. The backup source identification is used to instruct the backup source where the recovery point identification is located.

The backup control center generates the data recovery task and delivers the data recovery task to the corresponding client of the cloud server. The data recovery task is used to enable the cloud server to execute the data recovery task through the client, acquire the fifth backup index corresponding to the third target data from the backup repository, then read the third target data in the fifth backup index through the data recovery parameter, and write the third target data into the target directory of the second backup source corresponding to the destination backup source identification.

Therefore, through the above implementations, data recovery can be quickly realized. Moreover, the data recovery task is executed by the client, which is highly versatile.

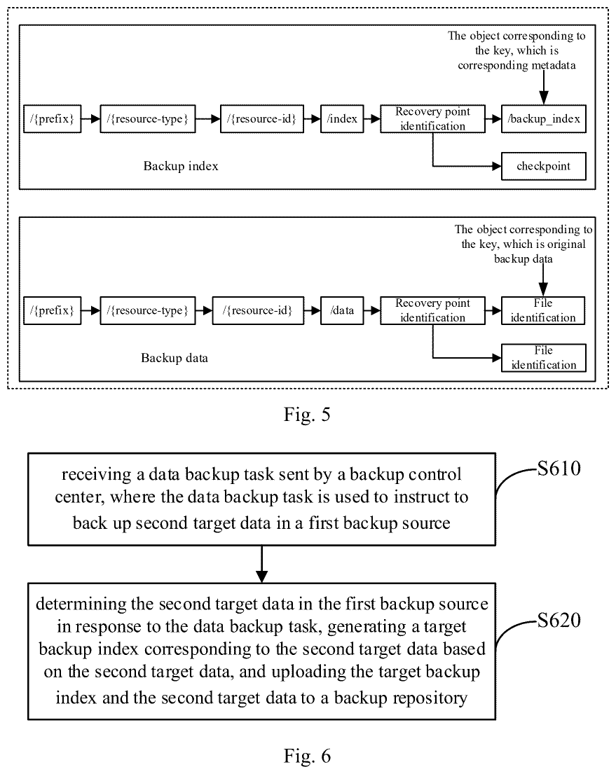

FIG. 6 is a flowchart of a data backup method according to other embodiments. As shown in FIG. 6, in some implementations that may be implemented, a data backup method is provided, and the method is executed by the cloud server in FIG. 1. The method may include the following steps.

S610: receiving a data backup task sent by a backup control center, where the data backup task is used to instruct to back up second target data in a first backup source.

S620: determining the second target data in the first backup source in response to the data backup task, generating a target backup index corresponding to the second target data based on the second target data, and uploading the target backup index and the second target data to a backup repository.

The backup data and the backup index stored in the backup repository are used for: when the backup control center deletes a recovery point in the backup repository, the backup control center determines a recovery point deletion task used to instruct to delete a target recovery point in the backup repository, and through a backup work service node, determines first target data to be deleted according to a first backup index corresponding to the target recovery point, a second backup index corresponding to a preceding recovery point of the target recovery point, and a third backup index corresponding to a subsequent recovery point of the target recovery point in response to the recovery point deletion task, and deletes the first target data from the backup repository, and deletes the first backup index from the backup repository.

For the detailed description of the above steps S610 to S620, reference may be made to the related description of the above embodiments, which will not be repeated here.

Optionally, in step S620, the cloud server may access the first backup source through a client deployed in the cloud server based on an access protocol adapted to a type of the first backup source in preconfigured access protocols, execute the data backup task and generate the target backup index corresponding to the second target data, and upload the target backup index and the second target data to the backup repository.

Optionally, in step S620, the backup repository includes user storage space, and the user storage space supports a tenant of the cloud server to access the backup indexes and the backup data. Accordingly, the target backup index and the second target data may be uploaded to the user storage space through the client.

Optionally, the backup repository adopts an object storage data storage architecture or a network attached storage data storage architecture, and the user storage space includes a bucket in the object storage or a designated directory in the network attached storage.

Optionally, the data backup task includes an incremental backup task, the incremental backup task includes a target recovery point identification, a backup source identification corresponding to the first backup source, a preceding recovery point identification corresponding to the target recovery point identification, and a data backup parameter. The data backup parameter is used to instruct to back up the second target data in the first backup source.

Accordingly, step S620 may include:
the cloud server, through the client, determines a fourth backup index corresponding to the preceding recovery point identification according to the preceding recovery point identification in response to the incremental backup task, scans the first backup source indicated by the backup source identification according to the data backup parameter, determines the second target data to be backed up, and generates the target backup index corresponding to the target recovery point identification according to the second target data; and determines incremental backup data in the second target data included in the target backup index according to the target backup index and the fourth backup index, and uploads the target backup index and the incremental backup data to the backup repository.

Optionally, the backup indexes are stored in the backup repository through a preset data organization form, and the data organization form includes at least one of the following parameters:
an environment identification used to characterize a business environment where the target backup sources corresponding to the backup indexes are located, a backup source type used to characterize the types of the target backup sources, backup source identifications corresponding to the target backup sources, recovery point identifications corresponding to the backup indexes, a backup directory used to store backup data corresponding to the backup indexes, and backup checkpoints corresponding to the backup indexes.

Optionally, the cloud server may further receive a data recovery task sent by the backup control center, where the data recovery task is used to instruct to recover third target data in the backup repository to a designated second backup source. The cloud server acquires a fourth backup index corresponding to the third target data from the backup repository through a client deployed in the cloud server in response to the data recovery task, and writes the third target data into the second backup source according to the fourth backup index through the client.

It should be noted that for the above implementations, reference may be made to the related description of the data backup method corresponding to the data backup system, which will not be repeated here.

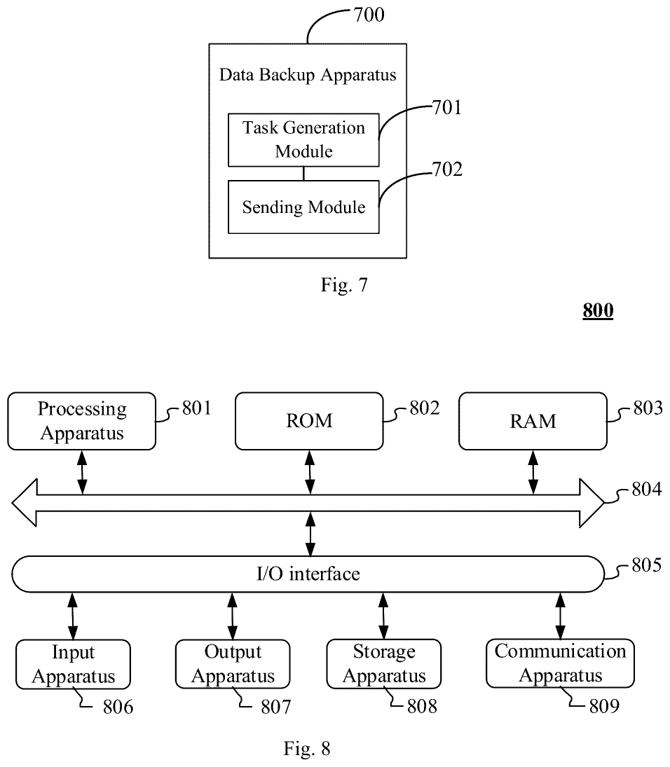

FIG. 7 is a schematic diagram of a structure of a data backup apparatus according to some embodiments. As shown in FIG. 7, a data backup apparatus 700 is provided, and the data backup apparatus 700 may be configured in the backup control center shown in FIG. 1. The data backup apparatus 700 may include:
a task generation module 701 configured to generate a recovery point deletion task, where the recovery point deletion task is used to instruct to delete a target recovery point in a backup repository, and the backup repository is used to manage backup data and backup indexes corresponding to respective recovery points; and
a sending module 702 configured to deliver the recovery point deletion task to a backup work service node, and instruct the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

Optionally, the sending module 702 is further configured to:
determine, from backup data included in the first backup index, first backup data that is not inherited from the second backup index according to the first backup index and the second backup index; and
determine, from the first backup data, second backup data that is not referenced by the third backup index according to the first backup index and the third backup index, and determine the second backup data as the first target data.

Optionally, the data backup apparatus 700 further includes:
a first determination module configured to determine a data backup task, where the data backup task is used to instruct to back up second target data of a first backup source in a cloud server; and
a task delivery module configured to deliver the data backup task to the cloud server, where the data backup task is used to enable the cloud server to access the first backup source through a client based on an access protocol adapted to a type of the first backup source in a preconfigured access protocol, and execute the data backup task to generate a target backup index corresponding to the second target data, and upload the target backup index and the second target data to the backup repository.

Optionally, the backup repository includes user storage space, and the user storage space supports a tenant of the cloud server to access the backup indexes and the backup data; and the task delivery module is further configured to:
upload the target backup index and the second target data to the user storage space through the client.

Optionally, the backup repository adopts an object storage data storage architecture or a network attached storage data storage architecture, and the user storage space includes a bucket in the object storage or a designated directory in the network attached storage.

Optionally, the data backup task includes an incremental backup task, the incremental backup task includes a target recovery point identification, a backup source identification corresponding to the first backup source, a preceding recovery point identification corresponding to the target recovery point identification, and a data backup parameter, and the data backup parameter is used to instruct to back up the second target data in the first backup source; and
the task delivery module is further configured to:
execute the incremental backup task through the client, and determine, according to the preceding recovery point identification, a fourth backup index corresponding to the preceding recovery point identification;
scan the first backup source indicated by the backup source identification through the client according to the data backup parameter, determine the second target data to be backed up in the first backup source, and generate the target backup index corresponding to the target recovery point identification according to the second target data;
determine incremental backup data in the second target data included in the target backup index through the client according to the target backup index and the fourth backup index; and
upload the target backup index and the incremental backup data to the backup repository through the client.

Optionally, the data backup apparatus 700 further includes:
a second determination module configured to determine a data recovery task, where the data recovery task is used to instruct to recover third target data in the backup repository to a second backup source that is designated in the cloud server;
an execution module configured to execute the data recovery task through a client deployed in the cloud server, and acquire a fifth backup index corresponding to the third target data from the backup repository; and
a writing module configured to write the third target data into the second backup source according to the fifth backup index through the client.

The backup index is stored in the backup repository through a preset data organization form, and the data organization form includes at least one of the following parameters:
an environment identification used to characterize a business environment where the target backup source corresponding to the backup index is located, a backup source type used to characterize the type of the target backup source, a backup source identification corresponding to the target backup source, a recovery point identification corresponding to the backup index, a backup directory used to store backup data corresponding to the backup index, and a backup checkpoint corresponding to the backup index; and
the data backup apparatus 700 further includes:
a display module configured to display the backup indexes according to the data organization form in response to a viewing operation for the backup indexes.

Reference is made to FIG. 8 below, which illustrates a schematic diagram of a structure of an electronic device 800 (such as the backup control center or the cloud server in FIG. 1) suitable for implementing the embodiments of the present disclosure. The backup control center in the embodiments of the present disclosure may include, but is not limited to, mobile terminals such as a mobile phone, a notebook computer, a digital broadcast receiver, a PDA (personal digital assistant), a PAD (tablet computer), a PMP (portable multimedia player), and an in-vehicle terminal (such as an in-vehicle navigation terminal), and fixed terminals such as a digital TV and a desktop computer. The electronic device shown in FIG. 8 is only an example, and should not impose any limitation on the function and scope of use of the embodiments of the present disclosure.

As shown in FIG. 8, the electronic device 800 may include a processing apparatus 801 (such as a central processing unit, a graphics processing unit, etc.), which may perform various appropriate actions and processes according to a program stored in a read-only memory (ROM) 802 or a program loaded from a storage apparatus 808 into a random access memory (RAM) 803. In the RAM 803, various programs and data required for the operation of the electronic device 800 are also stored. The processing apparatus 801, the ROM 802, and the RAM 803 are connected with each other through a bus 804. An input/output (I/O) interface 805 is also connected to the bus 804.

Generally, the following apparatus may be connected to the I/O interface 805: an input apparatus 806 including, for example, a touchscreen, a touchpad, a keyboard, a mouse, a camera, a microphone, an accelerometer, a gyroscope, and the like; an output apparatus 807 including, for example, a liquid crystal display (LCD), a speaker, a vibrator, and the like; a storage apparatus 808 including, for example, a magnetic tape, a hard disk, and the like; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all of the illustrated apparatuses. Alternatively, more or fewer apparatuses may be implemented or provided.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program includes program codes for executing the methods shown in the flowcharts. In such an embodiment, the computer program may be downloaded and installed from a network through the communication apparatus 809, or installed from the storage apparatus 808, or installed from the ROM 802. When the computer program is executed by the processing apparatus 801, the above functions defined in the methods of the embodiments of the present disclosure are executed.

It should be noted that the above-mentioned computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program that may be used by or in conjunction with an instruction execution system, apparatus, or device. In the present disclosure, the computer-readable signal medium may include a data signal propagated in a baseband or as part of a carrier wave, and computer-readable program codes are carried therein. The propagated data signal may be in various forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program used by or in conjunction with an instruction execution system, apparatus, or device. The program codes contained on the computer-readable medium may be transmitted by any suitable medium, including but not limited to an electric wire, an optical cable, RF (radio frequency), or any suitable combination of the above.

In some implementations, the backup control center and the cloud server may communicate using any currently known or future developed network protocol such as HTTP (HyperText Transfer Protocol), and may be interconnected with digital data communication (for example, a communication network) in any form or medium. Examples of the communication network include a local area network (“LAN”), a wide area network (“WAN”), the Internet (for example, the Internet), and a peer-to-peer network (for example, an ad hoc peer-to-peer network), as well as any currently known or future developed network.

The above computer-readable medium may be included in the above electronic device; or may exist alone without being assembled into the electronic device.

The above computer-readable medium carries one or more programs, and when the above one or more programs are executed by the electronic device, the electronic device is caused to: generate a recovery point deletion task, where the recovery point deletion task is used to instruct to delete a target recovery point in a backup repository, and the backup repository is used to manage backup data and backup indexes corresponding to respective recovery points; and deliver the recovery point deletion task to a backup work service node, and instruct the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

The computer program codes for executing the operations of the present disclosure may be written in one or more programming languages or a combination thereof. The above programming languages include object-oriented programming languages such as Java, Smalltalk, and C++, as well as conventional procedural programming languages such as “C” language or similar programming languages. The program codes may be executed entirely on the user's computer, partly on the user's computer, as a stand-alone software package, partly on the user's computer and partly on a remote computer, or entirely on the remote computer or server. In the case of the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of code, which includes one or more executable instructions for implementing specified logical functions. It should also be noted that, in some alternative implementations, the functions noted in the block may occur out of the order noted in the drawings. For example, two blocks shown in succession may, in fact, can be executed substantially concurrently, or the blocks may sometimes be executed in a reverse order, depending upon the functionality involved. It should also be noted that, each block of the block diagrams and/or flowcharts, and combinations of blocks in the block diagrams and/or flowcharts, can be implemented by special-purpose hardware-based systems that perform the specified functions or acts, or combinations of special purpose hardware and computer instructions.

The modules involved in the embodiments described in the present disclosure may be implemented in software or hardware. The name of the module does not constitute a limitation on the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), and the like.

In the context of the present disclosure, a machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the foregoing. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept. For example, the technical solutions formed by replacing the above features with technical features with similar functions disclosed in the present disclosure (but not limited to).

In addition, although the operations are depicted in a specific order, this should not be understood as requiring these operations to be performed in the specific order shown or in a sequential order. Under certain circumstances, multitasking and parallel processing may be advantageous. Similarly, although the above discussion contains several specific implementation details, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. On the contrary, the specific features and actions described above are only example forms of implementing the claims. Regarding the apparatus in the above embodiments, the specific manner in which each module performs operations has been described in detail in the embodiments of the method, and will not be described in detail here.

1. A data backup method, comprising:
generating a recovery point deletion task, wherein the recovery point deletion task is used to instruct to delete a target recovery point in a backup repository, and the backup repository is used to manage backup data and backup indexes corresponding to respective recovery points; and
delivering the recovery point deletion task to a backup work service node, and instructing the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

2. The method according to claim 1, wherein the determining the first target data to be deleted according to the first backup index corresponding to the target recovery point, the second backup index corresponding to the preceding recovery point of the target recovery point, and the third backup index corresponding to the subsequent recovery point of the target recovery point comprises:
determining, from backup data comprised in the first backup index, first backup data that is not inherited from the second backup index according to the first backup index and the second backup index; and
determining, from the first backup data, second backup data that is not referenced by the third backup index according to the first backup index and the third backup index, and determining the second backup data as the first target data.

3. The method according to claim 1, further comprising:
determining a data backup task, wherein the data backup task is used to instruct to back up second target data of a first backup source in a cloud server; and
delivering the data backup task to the cloud server, wherein the data backup task is used to enable the cloud server to access the first backup source through a client based on an access protocol adapted to a type of the first backup source in a preconfigured access protocol, and execute the data backup task to generate a target backup index corresponding to the second target data and upload the target backup index and the second target data to the backup repository.

4. The method according to claim 3, wherein the backup repository comprises user storage space, and the user storage space supports a tenant of the cloud server to access the backup indexes and the backup data; and
wherein the uploading the target backup index and the second target data to the backup repository comprises:
uploading the target backup index and the second target data to the user storage space through the client.

5. The method according to claim 4, wherein a data storage architecture of the backup repository comprises object storage or network attached storage, and the user storage space comprises a bucket in the object storage or a designated directory in the network attached storage.

6. The method according to claim 3, wherein the data backup task comprises an incremental backup task, the incremental backup task comprises a target recovery point identification, a backup source identification corresponding to the first backup source, a preceding recovery point identification corresponding to the target recovery point identification, and a data backup parameter, and the data backup parameter is used to instruct to back up the second target data in the first backup source; and
the executing the data backup task to generate the target backup index corresponding to the second target data and upload the target backup index and the second target data to the backup repository comprises:
executing the incremental backup task through the client, and determining, according to the preceding recovery point identification, a fourth backup index corresponding to the preceding recovery point identification;
scanning the first backup source indicated by the backup source identification through the client according to the data backup parameter, determining the second target data to be backed up in the first backup source, and generating the target backup index corresponding to the target recovery point identification according to the second target data;
determining incremental backup data in the second target data comprised in the target backup index through the client according to the target backup index and the fourth backup index; and
uploading the target backup index and the incremental backup data to the backup repository through the client.

7. The method according to claim 1, further comprising:
determining a data recovery task, wherein the data recovery task is used to instruct to recover third target data in the backup repository to a second backup source that is designated in a cloud server;
executing the data recovery task through a client deployed in the cloud server, and acquiring a fifth backup index corresponding to the third target data from the backup repository; and
writing the third target data into the second backup source according to the fifth backup index through the client.

8. The method according to claim 1, wherein the backup indexes are stored in the backup repository through a data organization form that is preset, and the data organization form comprises at least one of following parameters:
an environment identification used to characterize a business environment where target backup sources corresponding to the backup indexes are located, a backup source type used to characterize types of the target backup sources, backup source identifications corresponding to the target backup sources, recovery point identifications corresponding to the backup indexes, a backup directory used to store backup data corresponding to the backup indexes, and backup checkpoints corresponding to the backup indexes; and
wherein the method further comprises:
displaying the backup indexes according to the data organization form in response to a viewing operation for the backup indexes.

9. A non-transitory computer-readable medium having a computer program stored thereon, wherein when the computer program is executed by a processing apparatus, a data backup method is implemented, wherein the method comprises:
generating a recovery point deletion task, wherein the recovery point deletion task is used to instruct to delete a target recovery point in a backup repository, and the backup repository is used to manage backup data and backup indexes corresponding to respective recovery points; and
delivering the recovery point deletion task to a backup work service node, and instructing the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

10. The non-transitory computer-readable medium according to claim 9, wherein the determining the first target data to be deleted according to the first backup index corresponding to the target recovery point, the second backup index corresponding to the preceding recovery point of the target recovery point, and the third backup index corresponding to the subsequent recovery point of the target recovery point comprises:
determining, from backup data comprised in the first backup index, first backup data that is not inherited from the second backup index according to the first backup index and the second backup index; and
determining, from the first backup data, second backup data that is not referenced by the third backup index according to the first backup index and the third backup index, and determining the second backup data as the first target data.

11. The non-transitory computer-readable medium according to claim 9, wherein the method further comprises:
determining a data backup task, wherein the data backup task is used to instruct to back up second target data of a first backup source in a cloud server; and
delivering the data backup task to the cloud server, wherein the data backup task is used to enable the cloud server to access the first backup source through a client based on an access protocol adapted to a type of the first backup source in a preconfigured access protocol, and execute the data backup task to generate a target backup index corresponding to the second target data and upload the target backup index and the second target data to the backup repository.

12. The non-transitory computer-readable medium according to claim 11, wherein the backup repository comprises user storage space, and the user storage space supports a tenant of the cloud server to access the backup indexes and the backup data; and
wherein the uploading the target backup index and the second target data to the backup repository comprises:
uploading the target backup index and the second target data to the user storage space through the client.

13. The non-transitory computer-readable medium according to claim 12, wherein a data storage architecture of the backup repository comprises object storage or network attached storage, and the user storage space comprises a bucket in the object storage or a designated directory in the network attached storage.

14. The non-transitory computer-readable medium according to claim 11, wherein the data backup task comprises an incremental backup task, the incremental backup task comprises a target recovery point identification, a backup source identification corresponding to the first backup source, a preceding recovery point identification corresponding to the target recovery point identification, and a data backup parameter, and the data backup parameter is used to instruct to back up the second target data in the first backup source; and
the executing the data backup task to generate the target backup index corresponding to the second target data and upload the target backup index and the second target data to the backup repository comprises:
executing the incremental backup task through the client, and determining, according to the preceding recovery point identification, a fourth backup index corresponding to the preceding recovery point identification;
scanning the first backup source indicated by the backup source identification through the client according to the data backup parameter, determining the second target data to be backed up in the first backup source, and generating the target backup index corresponding to the target recovery point identification according to the second target data;
determining incremental backup data in the second target data comprised in the target backup index through the client according to the target backup index and the fourth backup index; and
uploading the target backup index and the incremental backup data to the backup repository through the client.

15. The non-transitory computer-readable medium according to claim 9, wherein the method further comprises:
determining a data recovery task, wherein the data recovery task is used to instruct to recover third target data in the backup repository to a second backup source that is designated in a cloud server;
executing the data recovery task through a client deployed in the cloud server, and acquiring a fifth backup index corresponding to the third target data from the backup repository; and
writing the third target data into the second backup source according to the fifth backup index through the client.

16. The non-transitory computer-readable medium according to claim 9, wherein the backup indexes are stored in the backup repository through a data organization form that is preset, and the data organization form comprises at least one of following parameters:
an environment identification used to characterize a business environment where target backup sources corresponding to the backup indexes are located, a backup source type used to characterize types of the target backup sources, backup source identifications corresponding to the target backup sources, recovery point identifications corresponding to the backup indexes, a backup directory used to store backup data corresponding to the backup indexes, and backup checkpoints corresponding to the backup indexes; and
wherein the method further comprises:
displaying the backup indexes according to the data organization form in response to a viewing operation for the backup indexes.

17. An electronic device, comprising:
a storage apparatus having a computer program stored thereon; and
a processing apparatus configured to execute the computer program in the storage apparatus to implement a data backup method, which comprises:
generating a recovery point deletion task, wherein the recovery point deletion task is used to instruct to delete a target recovery point in a backup repository, and the backup repository is used to manage backup data and backup indexes corresponding to respective recovery points; and
delivering the recovery point deletion task to a backup work service node, and instructing the backup work service node to determine first target data to be deleted according to a first backup index corresponding to the target recovery point, a second backup index corresponding to a preceding recovery point of the target recovery point, and a third backup index corresponding to a subsequent recovery point of the target recovery point, and delete the first target data and the first backup index from the backup repository.

18. The electronic device according to claim 17, wherein the determining the first target data to be deleted according to the first backup index corresponding to the target recovery point, the second backup index corresponding to the preceding recovery point of the target recovery point, and the third backup index corresponding to the subsequent recovery point of the target recovery point comprises:
determining, from backup data comprised in the first backup index, first backup data that is not inherited from the second backup index according to the first backup index and the second backup index; and
determining, from the first backup data, second backup data that is not referenced by the third backup index according to the first backup index and the third backup index, and determining the second backup data as the first target data.

19. The electronic device according to claim 17, wherein the method further comprises:
determining a data backup task, wherein the data backup task is used to instruct to back up second target data of a first backup source in a cloud server; and
delivering the data backup task to the cloud server, wherein the data backup task is used to enable the cloud server to access the first backup source through a client based on an access protocol adapted to a type of the first backup source in a preconfigured access protocol, and execute the data backup task to generate a target backup index corresponding to the second target data and upload the target backup index and the second target data to the backup repository.

20. The electronic device according to claim 19, wherein the backup repository comprises user storage space, and the user storage space supports a tenant of the cloud server to access the backup indexes and the backup data; and
wherein the uploading the target backup index and the second target data to the backup repository comprises:
uploading the target backup index and the second target data to the user storage space through the client.
